(19) United States
(12) Patent Application Publication
(10) Pub. No.: US 2005/0108075 A1
(43) Pub. Date: May 19, 2005

(54) Method, apparatus, and program for adaptive control of application power consumption in a mobile computer

(75) Inventors: Frederick Douglis, Basking Ridge, NJ (US); Thomas Richard Hildner, Cary, NC (US); Claus Michael Olsen, Cortlandt Manor, NY (US)

Correspondence Address: DUKE. W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/715,945

(22) Filed: Nov. 18, 2003

(51) Int. Cl. G06F 17/60

(52) U.S. Cl. 705/8

(57) ABSTRACT

A power-aware monitor is provided for controlling the execution of state-unaware applications and optimizing their execution in light of power consumption issues. The power-aware monitor examines application usage to build profiles of resource consumption. When an application starts execution, the monitor determines the state of the battery to influence policy decisions. The monitor maintains a list of rules, which it uses in deciding policy. The user may modify these rules to override default behavior. The rules dictate whether an application executes unfettered, has its I/O, computation, or other activity restricted or delayed, or is completely aborted. When in doubt, the monitor may prompt the user for a decision.

### BACKGROUND OF THE INVENTION

1. Technical Field

The present invention relates to data processing systems and, in particular, to mobile computing devices. Still more particularly, the present invention provides a method, apparatus, and program for adaptive control of application power consumption in a mobile computer.

2. Description of Related Art

Despite advances in battery capacities, power consumption in mobile computing devices, such as laptop computers, continues to be a serious problem that limits the utility of these devices when running off batteries for an extended time: a single battery may allow as little as 1.5 hours of operation. Even the best of breed machines are far from the ideal goal of an “all day” or “multiple day” battery life system.

As mobile computing becomes more affordable, more and more of the overall market share is moving to mobile computing and away from desktop computing. As customers are realizing that processor power and other core technologies are “good enough,” the focus on mobility and usability are becoming more important to users. As wireless computing is becoming more pervasive, the attention is focused on the dependency on the “last wire,” the power cord.

Power is consumed by many system components, including the processor, graphics processor, core chipset, voltage regulator, display device, disk drive, memory, network connection, etc. Some of these components will consume power at a relatively constant rate, but most are dependent on state. For example, a disk drive consumes much less power when the disk is spun down, with its electronics in a sleep state, than when idling or transferring data.

In general, applications are relatively unaware of the power state of a mobile computer. State-unaware applications execute instructions and access resources, regardless of whether the computer is unplugged, or, if the computer is unplugged, whether its disk is spinning. In addition, applications are also written without regard for power consumptions as software programmers usually think of desktop processing as the main application.

There has been a great amount of work in the area of controlling individual resources, such as when a disk in a laptop computer should be spun down after periods of inactivity. See Douglis et al., “Adaptive Disk Spin-Down Policies for Mobile Computers,” 1995, Proc. 2^{nd} USENIX Symp. on Mobile and Location-Independent Computing. There has also been work in the area of varying the processor speed to trade off power against performance. See Weiser et al., “Scheduling for Reduced CPU Energy,” 1994, Operating Systems Design and Implementation. Other work in the prior art includes ad hoc networking and adapting the quality of execution to power requirements, for example playing lower fidelity video, or offloading computation. There has been recent work in clustering input/output (I/O) depending on the state of the disk.

General changes to operating system design have been proposed to improve energy efficiency. It has been observed that daemon processes such as garbage collection and disk compaction could be deferred when on battery, unless the degradation due to deferring these tasks outweighs the costs. Other aspects of energy optimization, such as placing data in DRAM in a way to optimize which parts of memory are accessed together while letting other parts of memory go into an inactive state have been recognized. An energy-conscious operating-system has been proposed in Zeng et al, “ECOSystem: Managing Energy as a First Class Operating System Resource”, 2002, Symposium on Architectural Support for Programming Languages and Operating Systems. ECOSystem charges applications for their battery consumption as a way of controlling resource use.

Mobile computing devices have become more pervasive in homes and home offices. Many current mobile computing devices do not have operating systems and applications that are specialized for mobile computing. In fact, many laptop computers have standard desktop operating systems installed thereon. Casual computer users may be unaware of resource consumption. Therefore, mobile computer users may unknowingly install and utilize resource-intensive applications, such as virus scan and disk defragmentation applications. Many applications, such as software update utilities or streaming audio player consoles run in the background without the user being aware.

### SUMMARY OF THE INVENTION

The present invention recognizes the disadvantages of the prior art and provides a resource-aware monitor for controlling the execution of state-unaware applications and optimizing their execution in light of resource consumption issues. The resource-aware monitor examines application usage to build profiles of resource consumption. When an application starts execution, the monitor determines the state of the limited resource to influence policy decisions. The monitor maintains a list of rules, which it uses in deciding policy. The user may modify these rules to override default behavior. The rules dictate whether an application executes unfettered, has its I/O, computation, or other activity restricted or delayed, or is completely aborted. When in doubt, the monitor may prompt the user for a decision.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram illustrating an exemplary data processing system with a power-aware monitor in accordance with a preferred embodiment of the present invention;

FIGS. 4A and 4B depict example screens prompting the user to make a policy decision for a power-aware monitor in accordance with a preferred embodiment of the present invention;

FIG. 5 is a flowchart illustrating the operation of a power-aware monitor in accordance with a preferred embodiment of the present invention;

FIG. 6 is a flowchart illustrating the operation of resource restriction during execution in accordance with a preferred embodiment of the present invention; and

FIG. 7 is a flowchart illustrating the operation of power transitions in accordance with a preferred embodiment of the present invention.

### DETAILED DESCRIPTION OF THE PREFERRED EMBODIMENT

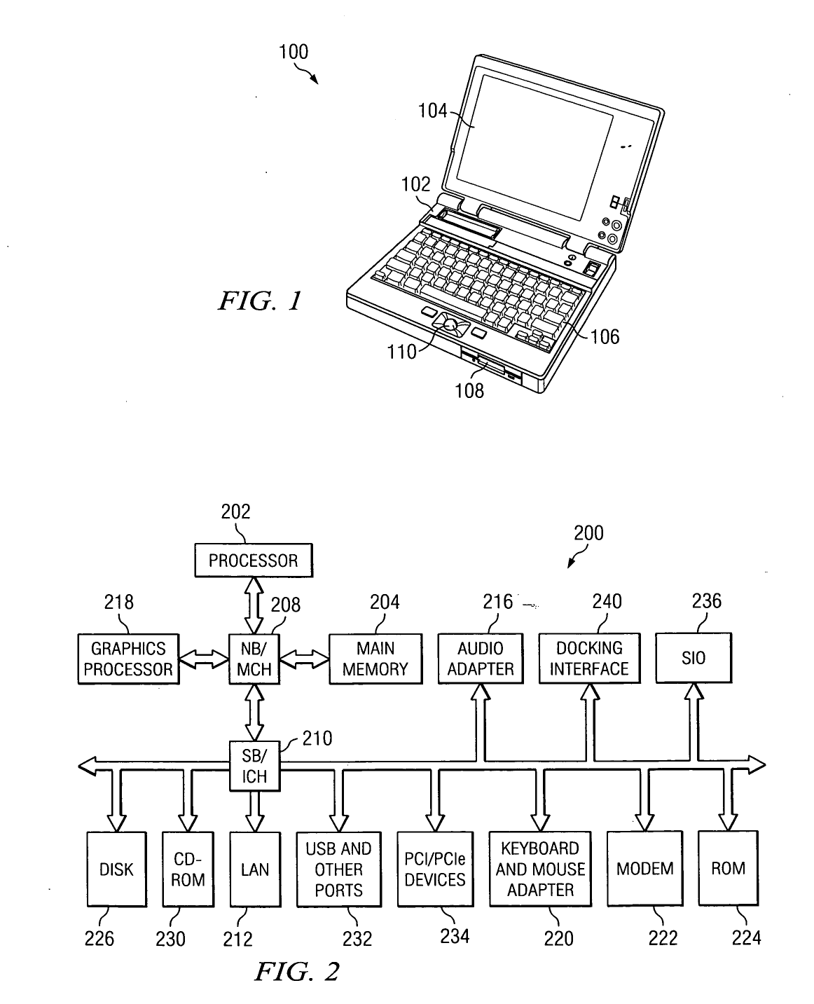

With reference now to the figures and in particular with reference to FIG. 1, a pictorial representation of a data processing system in which the present invention may be implemented is depicted in accordance with a preferred embodiment of the present invention. A mobile computer 100 is depicted which includes system unit 102, video display terminal 104, keyboard 106, storage devices 108, which may include floppy drives and other types of permanent and removable storage media, and pointer device 110. Additional input devices maybe included with mobile computer 100, such as, for example, a mouse, joystick, touch screen, trackball, microphone, and the like. Mobile computer 100 man be implemented using any suitable computer, such as an IBM Thinkpad computer, which is a product of International Business Machines Corporation, located in Armonk, N.Y. Computer 100 also preferably includes a graphical user interface (GUI) that may be implemented by means of systems software residing in computer readable media in operation within computer 100.

Mobile computer 100 may run on alternating current (A/C) power or battery power. In fact, a main advantage and purpose of mobile computing devices is location independence. Thus, the ability to operate the computer on battery power is of significant concern to users. However, battery power is a limited resource and some components of computer 100 consume more power than others. For example, graphics processors, hard disk drives, compact disk drives, wireless network interface cards, and the like consume considerable power, which may be a concern when in battery mode. Particularly, components with moving parts, such as hard disk drives, are recognized as relatively high consumers of power.

Users of mobile computing devices may be unaware of the actual power usage by components and, more particularly, software applications. Many users operate a mobile computer, such as a laptop computer, as they would a desktop computer. That is, they may install and utilize many applications that consume resources, and running these applications is completely appropriate when the computer is on A/C power. However, many of these applications may be avoided when in battery mode or using other limited resources. For example, a virus scan application may be invoked by a scheduler to scan the entire hard drive for viruses. Other applications, such as disk defragmentation applications, could be deferred or disabled while on battery power.

In accordance with a preferred embodiment of the present invention, mobile computer 100 includes a resource-aware monitor for controlling the execution of state-unaware applications and optimizing their execution in light of resource consumption issues. The resource-aware monitor examines application usage to build profiles of resource consumption. When an application starts execution, the monitor determines the state of the limited resource to influence policy decisions. The monitor maintains a list of rules, which it uses in deciding policy. The user may modify these rules to override default behavior. The rules dictate whether an application executes unfettered, has its I/O, computation, or other activity restricted or delayed, or is completely aborted. When in doubt, the monitor may prompt the user for a decision.

With reference now to FIG. 2, a block diagram of a data processing system is shown in which the present invention may be implemented. Data processing system 200 is an example of a mobile computer, such as computer 100 in FIG. 1, in which code or instructions implementing the processes of the present invention may be located. In the depicted example, data processing system 200 employs a hub architecture including a north bridge and memory controller hub (MCH) 208 and a south bridge and input/output (I/O) controller hub (ICH) 210. Processor 202, main memory 204, and graphics processor 218 are connected to MCH 208. Graphics processor 218 may be connected to the MCH through an accelerated graphics port (AGP), for example.

In the depicted example, local area network (LAN) adapter 212, audio adapter 216, keyboard and mouse adapter 220, modem 222, read only memory (ROM) 224, hard disk drive (HDD) 226, CD-ROM driver 230, universal serial bus (USB) ports and other communications ports 232, and PCI/PCIe devices 234 may be connected to ICH 210.

PCI/PCIe devices may include, for example, Ethernet adapters, add-in cards, PC cards for notebook computers, etc. PCI uses a cardbus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to ICH 210.

Docking interface 240 may also be connected to the ICH. Data processing system 200 may be a mobile computing device, such as a laptop computer or handheld computer. Docking interface 240 provides port replication to allow the data processing system to easily connect to a keyboard, pointing device, monitor, printer, speakers, etc. The docking interface allows the mobile computing device to operate as a desktop computer with the more immobile peripheral devices.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202. The processes of the present invention are performed by processor 202 using computer implemented instructions, which may be located in a memory such as, for example, main memory 204, memory 224, or in one or more peripheral devices 226 and 230.

Those of ordinary skill in the art will appreciate that the hardware in FIG. 2 may vary depending on the implementation. Other internal hardware or peripheral devices, such as flash memory, equivalent nonvolatile memory, or optical disk drives and the like, may be used in addition to or in place of the hardware depicted in FIG. 2. Also, the processes of the present invention may be applied to a multiprocessor data processing system.

For example, data processing system 200 may be a personal digital assistant (PDA), which is configured with flash memory to provide non-volatile memory for storing operating system files and/or user-generated data. The depicted example in FIG. 2 and above-described examples are not meant to imply architectural limitations. For example, data processing system 200 also may be a tablet computer or telephone device in addition to taking the form of a PDA.

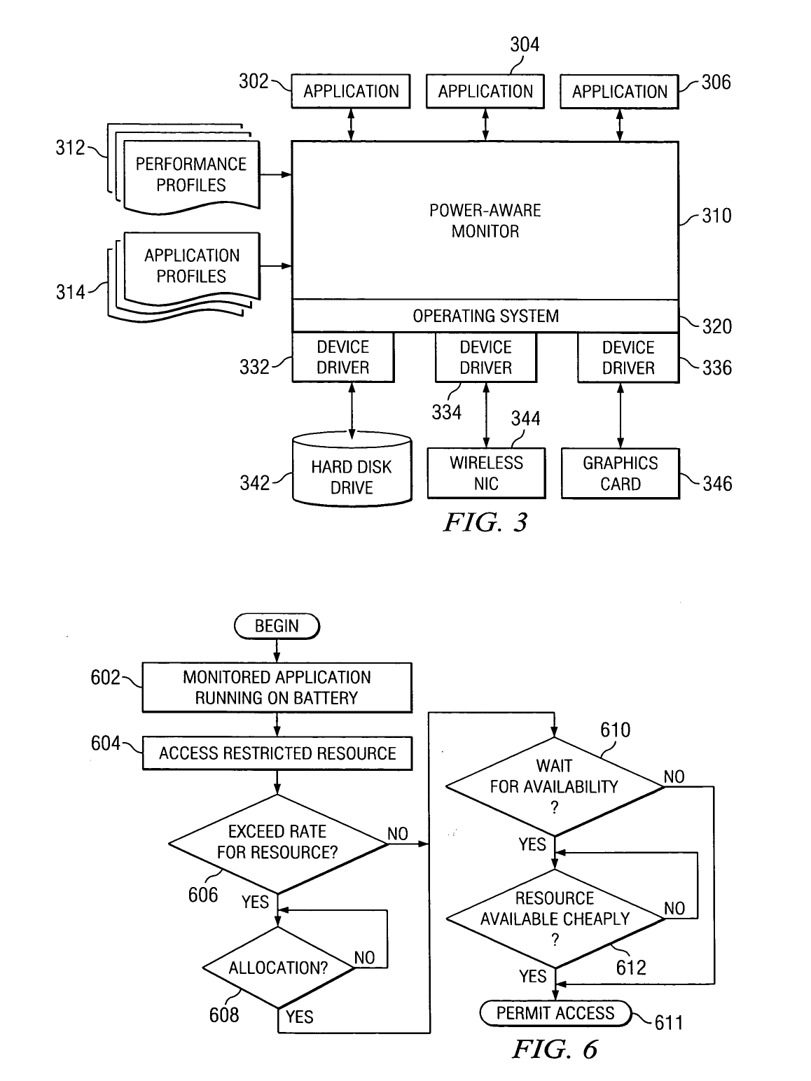

FIG. 3 is a block diagram illustrating an exemplary data processing system with a power-aware monitor in accordance with a preferred embodiment of the present invention. Operating system 320 runs on a data processing system and applications 302, 304, 306 run in the operating environment of operating system 320. Applications 302, 304, 306 may access one or more devices through device drivers 332, 334, 336. For example, device driver 332 may provide access to hard disk drive 342, device driver 334 may provide access to wireless network interface card (NIC) 334, and device driver 336 may provide access to graphics card 346.

In accordance with a preferred embodiment of the present invention, power-aware monitor 310 monitors applications 302, 304, 306. The power-aware monitor has several goals. One goal is to defer the execution of non-critical background tasks. These background tasks may be daemons and other applications that do not directly interact with the user and whose execution is desirable only when there is not a restriction on power usage. Examples include full disk virus scans, file system backups, disk defragmentation, application auto-updating, and peer-to-peer services, such as providing storage or computation.

Another goal of the power-aware monitor is to reduce resource consumption during active tasks. Some examples include a system that only allows rendering of two-dimensional (2D) graphics versus three-dimensional (3D) graphics, a system that disallows power-hungry input/output (I/O) commands, or a system that disables virtual memory to avoid page faults. All of these examples would increase battery life.

It is also a goal of the power-aware monitor to reschedule operations and/or reduce the frequency of operations to optimize for battery savings. A write to disk can often be deferred if the disk is spun down. In some cases, read operations may also be delayed. The frequency of auto-saving a file may be reduced if the disk is spun down, until a maximum timeout is reached or the disk spins up for another purpose. Wireless networks that poll for base stations may reduce the frequency of polling when on battery power. Additionally, some background tasks that involve periodic network activity as a keep-alive, such as instant messaging and polling for mail, may be suspended, spaced out, or terminated.

Power-aware monitor 310 may monitor application usage to build profiles of resource consumption, so that when an application starts execution, the monitor can support the application automatically. It would then monitor the state of the battery, using the system's predictions of remaining battery lifetime or, if needed, its own predictions, to influence a policy decision. The power-aware monitor may maintain a list of rules, which it would use in making a policy decision. The user may modify these rules to override default behavior. The rules may dictate whether an application should execute unfettered, have its I/O, computation, or other activity restricted or delayed, or be completely aborted. When in doubt, the power-aware monitor may prompt the user for a decision.

The power-aware monitor builds a database of application profiles 314, wherein each profile includes rules for a respective application. Application profiles 314 may also include a list of permitted applications and a list of banned applications. When a policy is set for an application, the application may be added to a list of permitted applications if the application is to be always permitted. Alternatively, the application may be added to a list of banned applications if the application is to be always denied. The rules for policy decisions may include one or more of the following:

Permit All Access:

Do not interfere with application behavior.

Deny All Access:

Do not permit this application to run when on battery power. If it begins execution, terminate the application. If the application is already executing when switching to battery power, terminate or suspend the application.

Defer (Start, Resource):

Delay starting execution of this application until the specified resource is “available,” e.g., when a disk is spun up or when a wireless interface becomes active.

Defer (Access, Resource):

Delay access to the specified resource until it is “available,” e.g., when a disk is spun up or when a wireless interface becomes active. This requires intercepting the I/O, not delaying the initiation of execution.

Defer (Execution, Resource):

Delay further execution of a running application until the resource is “available,” e.g., when a disk is spun up or when a wireless interface becomes active. This is distinct from deferring access, since it specifies that an application should be completely suspended, just as if execution were deferred from the start of execution. Note, this is not suitable for use with interactive applications, such as browsers, but unless such applications perform I/O asynchronously, deferring a single I/O will suspend the application regardless.

Limit (Resource, Rate):

Restrict accesses to the specified resource to a particular frequency. Note that for some applications, without support within the application for some sort of feedback, delaying an operation may freeze the application—this is often suitable for a background task, but may not be suitable for an interactive application, such as an editor performing an auto-save.

In addition to rules governing how applications use resources and how they are executed, power-aware monitor 310 may enable the system to reconfigure system parameters depending on the power mode. In particular, the amount of virtual memory allowed may be decreased while on battery power, excluding any applications that are already swapped out and inactive.

The power-aware monitor may also include a plurality of performance profiles 312 that define power constraints. For example, there may be a performance profile for full performance, low consumption, and the like. The user may select a performance profile for a usage session based upon demands and an expected time of usage. For example, a user may select a “full performance” profile if the user anticipates using many resources for a short period of time while on battery power; however, a user may select a “low consumption” profile if the user expects to be without A/C power for an extended period of time. The rules may then be applied according to the performance profile selected.

In accordance with an exemplary embodiment of the present invention, one or more of application profiles 314 may be initially received from providers through, for example, a dial-up connection or network interface. Application developers may provide application profiles as support for their products. For example, a virus scan application developer may provide an application profile for mobile users that indicates possible and, perhaps, recommended rules for the application. The profile may also include additional information about resource consumption, scheduling, criticality, security, and the like to educate the user when making a policy decision.

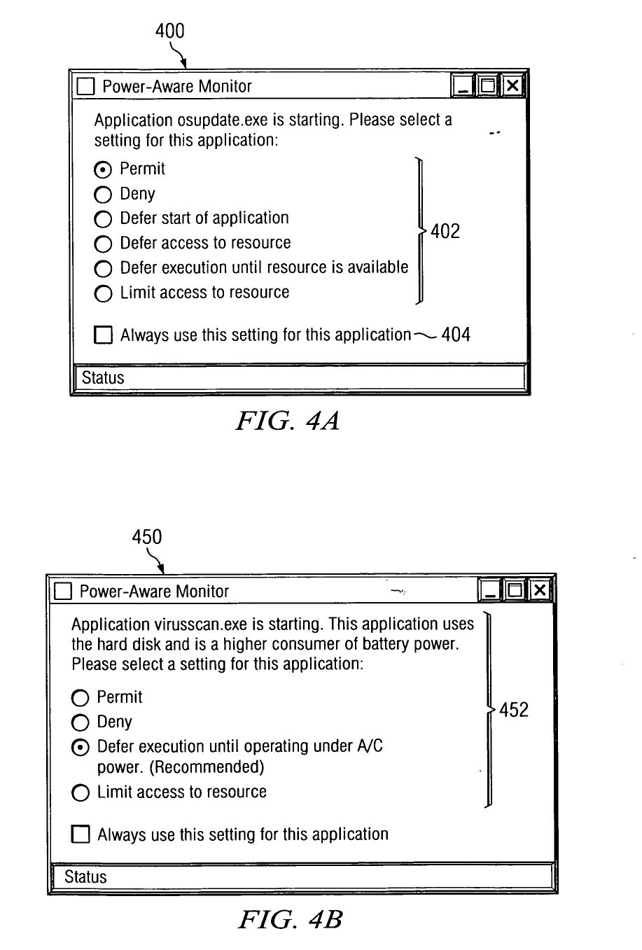

FIGS. 4A and 4B depict example screens prompting the user to make a policy decision for a power-aware monitor in accordance with a preferred embodiment of the present invention. With reference to FIG. 4A, window 400 is a dialog, which is presented when an application, “osupdate.exe,” is being initialized. A similar window may be presented when the data processing system is switched to battery power. The rules for the policy for the application are presented and the user may select a rule using radio buttons 402. The selected rule may be used only for the current invocation of the application. Alternatively, the user may select checkbox 404 to use the rule for every invocation of the application.

FIG. 4B illustrates a screen prompting the user for a policy decision based on an application profile received from an application developer. Window 450 is presented when application, “virusscan.exe,” is being initialized. A similar window may be presented when the data processing system switches from A/C to battery power. This dialog includes information 452 that is specific to the application. In this case, the application uses the hard disk and the monitor determines that the application uses a significant amount of battery power. The dialog informs the user of this information and recommends a rule to be applied, such as deferring execution of the application until the data processing system is operating under A/C power. The dialog may inform of other information, such as the last date/time the application executed, the next time the application is scheduled to execute, how long the application took to run on average or on a last occurrence, high/low power consumption, etc.

The examples in FIGS. 4A and 4B are meant as examples and not to limit the present invention. Modifications may be made to the manner in which the user is prompted for policy decisions within the scope of the present invention. For example, the text of the selections may be selectable to receive more information on the selection or rule. In the example shown in FIG. 4A, the user may click on or mouseover the word “Permit” to receive a description of this rule. The developers may alternatively provide hyperlinks to more information, such as Web pages hosted at the developer site. Other modifications to the examples in FIGS. 4A and 4B may be made depending upon the implementation.

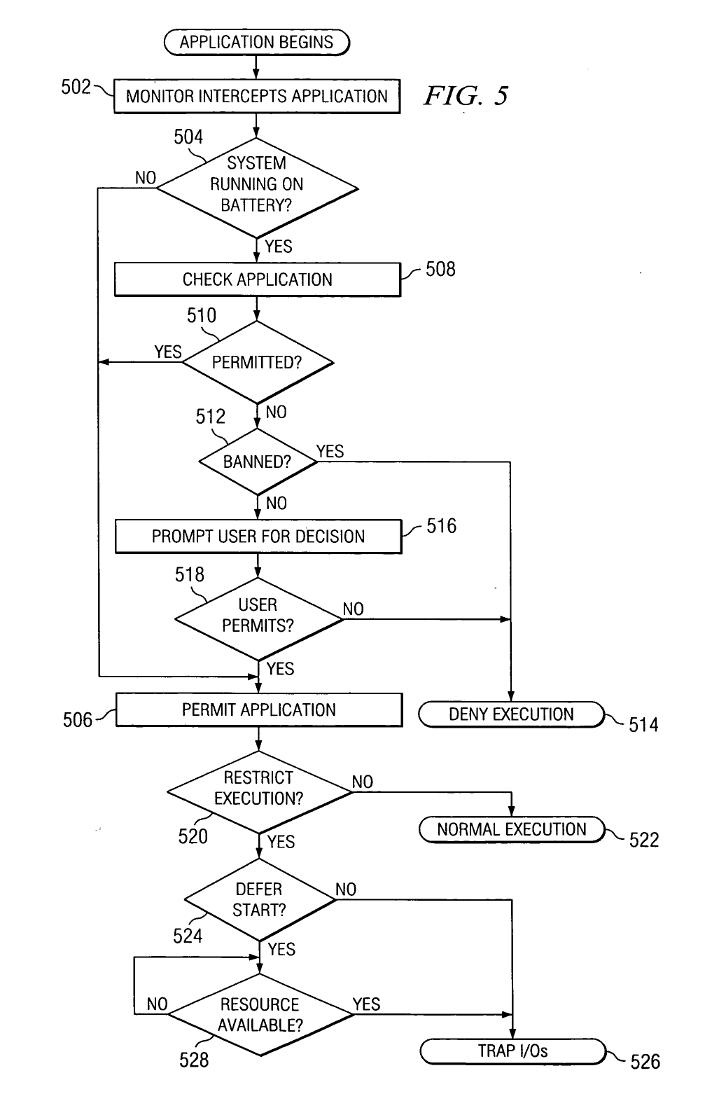

FIG. 5 is a flowchart illustrating the operation of a power-aware monitor in accordance with a preferred embodiment of the present invention. The process begins when an application begins execution. The monitor intercepts the application (step 502) and a determination is made as to whether the system is running on battery power (step 504). If the system is not running on battery power, the monitor permits normal execution of the application (step 522.)

If the system is running on battery power in step 504, the process checks the application (step 508) and a determination is made as to whether the application belongs to a list of permitted applications (step 510). This determination may be made by checking an actual list of permitted applications or by checking an individual profile for the application to determine whether the application is always permitted while on battery power. If the application belongs to a list of permitted applications, the monitor permits execution of the application (step 506).

If the application does not belong to a list of permitted applications in step 510, a determination is made as to whether the application belongs to a list of banned applications (step 512). This determination may be made by checking an actual list of banned applications or by checking an individual profile for the application to determine whether the application is always denied while on battery power. If the application belongs to a list of banned applications, the monitor denies execution (step 514) and the process ends.

If the application does not belong to a list of banned applications in step 512, the monitor prompts the user for a policy decision (step 516). A determination is made as to whether the user permits execution of the application (step 518). If the user permits the application, the monitor permits execution of the application (step 506). Otherwise, the monitor denies execution of the application (step 514) and the process ends.

After the monitor permits execution of the application in step 506, a determination is made as to whether execution is restricted (step 520). If execution is not restricted, the monitor allows normal execution (step 522) and the process ends. If execution is to be restricted in step 520, a determination is made as to whether start of the application is to be deferred (step 524). If the start of the application is not to be deferred, the monitor proceeds to trap I/Os (step 526) and the process ends.

If the start of the application is to be deferred in step 524, a determination is made as to whether a specified resource is available (step 528). If the resource is not available, step 528 repeats until the resource is available. If the resource is available in step 528, the monitor proceeds to trap I/Os (step 526) and the process ends.

With reference now to FIG. 6, a flowchart illustrating the operation of resource restriction during execution is shown in accordance with a preferred embodiment of the present invention. The process begins and a monitored application is running on battery power (step 602). The application accesses a restricted resource (step 604) and a determination is made as to whether the access exceeds an access rate for the resource (step 606). If the access exceeds an access rate for the resource, a determination is made as to whether an allocation is provided for the application (step 608). If an allocation is not provided, step 608 repeats to wait for an allocation.

If an allocation is provided in step 608 or if the access does not exceed an access rate for the resource in step 606, a determination is made as to whether to wait for availability of the resource (step 610). Responsive to a determination to wait for availability, a determination is made as to whether the resource is “cheaply available” (step 612). A resource is cheaply available if the resource is usable with a minimal incremental cost. For example, a hard disk drive is cheaply available if the disk is already spinning; however, if an application must spin up the disk to use it, then the hard disk drive is not considered to be cheaply available. If the resource is not cheaply available, step 612 repeats until the resource is cheaply available. Responsive to the resource becoming cheaply available in step 612 or to a determination to not wait for availability in step 610, the process permits access to the resource (step 614) and the process ends.

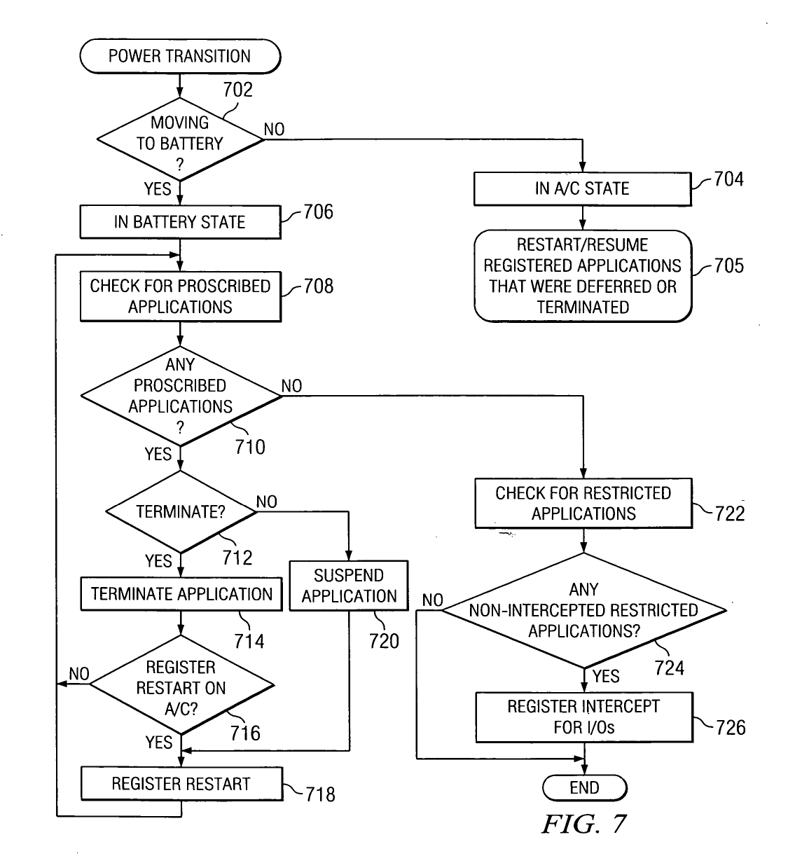

FIG. 7 is a flowchart illustrating the operation of power transitions in accordance with a preferred embodiment of the present invention. The process begins with a power transition. A determination is made as to whether power is moving to battery power (step 702). If the power transition is not to battery power, the data processing system is in A/C state (step 704). Then, the process restarts/resumes registered applications that were deferred or terminated (step 705) and ends.

If the power transition is moving to battery power in step 702, the data processing system is in battery state (step 706). Then, the process checks for proscribed applications (step 708). A determination is made as to whether there are any proscribed applications executing (step 710). If there are proscribed applications, a determination is made as to whether to terminate a given application (step 712). Responsive to a determination to terminate the given application, the process terminates the application (step 714) and a determination is made as to whether to register the application to restart upon a transition to A/C power (step 716). Responsive to a determination to not register the application to restart, the process returns to step 708 to check for proscribed applications.

Responsive to a determination to register the application to restart upon a transition to A/C power in step 716, the process registers the application to restart (step 718) and returns to step 708 to check for proscribed applications. Returning to step 712, responsive to a determination to not terminate the application, the process suspends the application (step 720) and registers the application to restart (step 718). Thereafter, the process returns to step 708 to check for proscribed applications.

Returning now to step 710, if there are no proscribed applications, the process checks for restricted applications (step 722). A determination is made as to whether there are any non-intercepted restricted applications executing (step 724). If there are no such applications, the process ends. If there are non-intercepted restricted applications executing in step 724, the process registers to intercept I/Os for the application (step 726). Thereafter, the process ends.

Thus, the present invention solves the disadvantages of the prior art by providing a power-aware monitor for controlling the execution of state-unaware applications and optimizing their execution in light of power consumption issues. The power-aware monitor examines application usage to build profiles of resource consumption. When an application starts execution, the monitor determines the state of the battery to influence policy decisions. The monitor maintains a list of rules, which it uses in deciding policy. The user may modify these rules to override default behavior. The rules dictate whether an application executes unfettered, has its I/O, computation, or other activity restricted or delayed, or is completely aborted. When in doubt, the monitor may prompt the user for a decision. The power-aware monitor of the present invention may execute without modification to applications or to the operating system. The power-aware monitor also may be customized to the hardware in the mobile computer, to individual performance profiles, or to the preferences of the user. The rules may also be applied dynamically to a changing operating environment to optimize power consumption when on battery power.

The present invention may also apply to limited resources other than battery power. For example, a data processing system may have a limited amount of memory. The monitor may determine the state of the limited resource to influence policy decisions. The monitor may also prompt the user for decisions. Thus, the resource-aware monitor may be customized to the hardware of the data processing system, to individual performance profiles, or to the preferences of the user.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for controlling execution of applications, the method comprising:
setting a policy for an application, wherein the policy indicates how to control execution of the application while the data processing system is using a limited resource;
responsive to initialization of the application while the data processing system is using the limited resource, controlling when to execute the application as determined by the policy; and
responsive to execution of the application while the data processing system is using the limited resource, controlling access of the application to specific elements of the data processing system that affect the limited resource.

2. The method of claim 1, wherein the limited resource is battery power.

3. The method of claim 1, wherein the policy indicates whether to execute the application, terminate the application, delay execution of the application, or suspend execution of the application.

4. The method of claim 1, wherein setting a policy includes prompting a user of the data processing system for a policy decision.

5. The method of claim 1, wherein controlling when to execute the application includes selectively suspending, terminating, or deferring invocation of the application until a specified element of the data processing system is non-idle.

6. The method of claim 1, wherein controlling access of the application to specific elements of the data processing system includes stalling access to a specified element of the data processing system by the application until the specified element is non-idle.

7. The method of claim 1, wherein controlling access of the application to specific elements of the data processing system includes suspending execution of the application until a specified element of the data processing system is non-idle.

8. The method of claim 1, wherein controlling access of the application to specific elements of the data processing system includes deferring execution of the application to maintain a designated rate of usage for a specified element of the data processing system.

9. The method of claim 1, further comprising:
building a profile of resource consumption for the application.

10. The method of claim 1, further comprising:
adding the application to a list of permitted applications if the application is to be always permitted.

11. The method of claim 1, further comprising:
adding the application to a list of banned applications if the application is to be always denied.

12. A method, in a data processing system, for controlling execution of applications, the method of comprising:
responsive to moving to battery power, identifying at least one application;
determining whether to terminate or suspend the at least one application; and
responsive to a determination to terminate the at least one application, terminating the at least one application.

13. The method of claim 12, further comprising:
registering the at least one application to restart when the data processing system is no longer using battery power.

14. The method of claim 12, further comprising:
responsive to a determination to suspend the application, suspending the at least one application.

15. The method of claim 14, further comprising:
registering the at least one application to restart when the data processing system is no longer using battery power.

16. An apparatus, in a data processing system, for controlling execution of applications, the apparatus comprising:
means for setting a policy for an application, wherein the policy indicates how to control execution of the application while the data processing system is using a limited resource;
means, responsive to initialization of the application while the data processing system is using the limited resource, for controlling when to execute the application as determined by the policy; and
means, responsive to execution of the application while the data processing system is using the limited resource, for controlling access of the application to specific elements of the data processing system that affect the limited resource.

17. A computer program product, in a computer readable medium, for controlling execution of applications in a data processing system, the computer program product comprising:
instructions for setting a policy for an application, wherein the policy indicates how to control execution of the application while the data processing system is using a limited resource;
instructions, responsive to initialization of the application while the data processing system is using the limited resource, for controlling when to execute the application as determined by the policy;
instructions, responsive to execution of the application while the data processing system is using the limited resource, for controlling access of the application to specific elements of the data processing system that affect the limited resource.

18. The computer program product of claim 17, wherein the limited resource is battery power.

19. The computer program product of claim 17, wherein the policy indicates whether to execute the application, terminate the application, delay execution of the application, or suspend execution of the application.

20. The computer program product of claim 17, wherein the instructions for setting a policy includes instructions for prompting a user of the data processing system for a policy decision.

21. The computer program product of claim 17, wherein the instructions for controlling when to execute the application includes instructions for selectively suspending, terminating, or deferring invocation of the application until a specified element of the data processing system is non-idle.

22. The computer program product of claim 17, wherein the instructions for controlling access of the application to specific elements of the data processing system includes instructions for stalling access to a specified element of the data processing system by the application until the specified element is non-idle.

23. The computer program product of claim 17, wherein the instructions for controlling access of the application to specific elements of the data processing system includes instructions for suspending execution of the application until a specified element of the data processing system is non-idle.

24. The computer program product of claim 17, wherein the instructions for controlling access of the application to specific elements of the data processing system includes instructions for deferring execution of the application to maintain a designated rate of usage for a specified element of the data processing system.
